(19) United States
(12) Patent Application Publication
(10) Pub. No.: US 2002/0042744 A1
(43) Pub. Date: Apr. 11, 2002

(54) Internet trading cards, system and method

(76) Inventor: Clayton G. Kohl, Irving, TX (US)

Correspondence Address: NIXON & VANDERHYE P.C., 8th Floor, 1100 North Glebe Road, Arlington, VA, 22201, US

(21) Appl. No.: 09/969,129

(22) Filed: Oct. 3, 2001

Related U.S. Application Data
(60) Provisional application No. 60/237,695, filed on Oct. 5, 2000.

(51) Int. Cl. G06F 17/60

(52) U.S. Cl. 705/14

(57) ABSTRACT

An Internet trading card system and method that promotes vendor's goods and services through the distribution of both physical and virtual collectible trading cards. Consumers request the trading cards by visiting a vendor's site and registering to receive the respective card. The trading cards carry vendor product or service information and unique identification numbers that are used to facilitate the consumers participation in promotions offered by the vendor. The Internet trading card company has a web site that promotes the cards and respective vendor sites through, among other items, a virtual card catalogue.

This application claims the benefit of U.S. Provisional Application Serial No. 60/237695, which was filed Oct. 5, 2000, the disclosure of which is incorporated herein by this reference.

### FIELD OF THE INVENTION

The invention relates to a product, system, and method that provide those who actively use a global computer network (such as the Internet) a mechanism whereby they can obtain a trading card at little or no cost, which also can provide them with information about a web site or a company having a web site, that they can use to participate in the web site promotion or decide whether to access that web site and/or do business with the company maintaining the web site, or to keep a tangible record of what the web site is about and where it is located on the global computer network. Entities that have web sites on a global computer network, for near nothing if sent electronically or for the cost of printing and mailing if sent physically, can deliver their brand identity while permissibly gaining valuable customer contact information which can be used to further market themselves, their products, and their services, through other more effective marketing mediums both traditional and electronic.

### BACKGROUND OF THE INVENTION

At present Internet marketing systems are using both overt and hidden methods to gain customer information, for which consumers are beginning to balk at this perceived privacy intrusion. For example, some companies have employed marketing methods that require visitors to enter personal information such as one's, gender, birth date, and interests, before gaining access to some promotion, product, or service. Other Internet marketing companies, use cookies to track consumer preferences and build detailed profiles about them. The Feb. 14, 2000 issue of Business Week carried an article entitled “Privacy: Outrage on the web” which described a lawsuit alleging violation of privacy rights and deceptive business practices. Consumer complaints have the US Congress introducing bills that require companies on the Internet to better inform consumers about their practices.

To create customers traffic, some companies have used systems that allow consumers to earn points that lead to prizes in exchange for visiting different web sites in the program. The points neither create valuable traffic nor remind consumers of the participating web sites from which these points were earned and prizes were obtained. The points systems create loyalty to the third party that implements the system rather than the web sites participating in the program itself.

The point based systems, and companies that run similar reward programs, attract an audience that is of little value when translating the site's traffic into real dollar revenue. A motto that calls for users to “earn points for prizes” attracts an audience of freebie scavengers. As the marketplace transitions from valuing sites based on traffic to valuing sites based on bottom line revenues, these marketing companies will be hard-pressed to justify their contribution to a company's bottom line. Such marketing systems do note provide a true consumer-generating portal, but merely a prize-winning barrel.

The prior art lacks the ability to permissibly deliver, both physically and electronically, an entities brand identity directly to the consumers. In addition, the prior art lacks the “phenomenon potential” associated with the rather limited method employed by the chosen marketing vehicle.

### SUMMARY OF THE INVENTION

Unlike the prior art systems described above, this invention is completely voluntary and requests only the name, e-mail address, and physical address of the individual for the purpose of delivering a trading card. The invention encourages the validity of contact information by sending the trading card to the physical address entered, and by releasing prizes to the name specified, on a Request Form. Thus the system of the present invention offers a card delivery system versus an intrusive, information seeking “head hunter.”

The invention uses a trading card system as a promotion to create interest while delivering the web site's client brand, name and location in the form of a fun card with perceived value. The card's perceived value is a function of its quality and the promotion associated with the card and the web site from which it was requested. The invention is based on the premise that client sites with a solid product do not need loyalty solutions for they have little trouble keeping clientele. The real marketing value is in attracting, creating, and capturing, new consumers.

Unlike the prior art, the invention doesn't focus on the accumulation of points or guaranteed prizes. Instead it concentrates on the efficient delivery of the client site's identity in the form of a tangible card. A primary goal of the invention is the delivery of a site's brand identity.

The invention provides consumers with an artistic Internet momento and the client sites with the “phenomenon potential” associated with a collectible card and the new visits and traffic generated by interested consumers. The card can be provided in hard copy form by, for example, first class mail, or the card can be provided electronically as a virtual card over, for example, the Internet.

As compared to the prior art, the inventive system offers client sites a better way to heighten brand awareness, to increase site traffic, and to permissibly capture customer information. The inventive system will be desirable to client sites for the following reasons:

The inventive system provides a fresh and innovative solution for delivering the brand identity, identifying the online visitor, and implementing a promotion effective, for example, web site giveaway.

The inventive system safeguards the consumers' privacy and encourages consumers to value the client sites and their representative cards. Unlike other systems where advertising is pushed at an audience, the inventive system allows consumers to choose when and where they release their contact information in exchange for a trading card and entry into the promotion. Thus, the consumer is inherently interested in receiving the requested card and is receptive to “hearing” the company message being communicated.

Trading cards are visually stunning with intriguing graphics that succeed in making the virtual experience of the web tangible. Consumers will likely value the limited-edition cards, since they honor the graphic artists, images, content, and content managers that make the web site truly possible.

The inventive system provides each web site with a passive interface that will neither disrupt nor disturb their visitors' web experience. The online consumers will not be forced to leave their current web site in order to participate in the promotion. The inventive system is an unobtrusive, subtle, and creative way for a web site to market itself and to capture contact information on its visitors.

The present invention, that incorporates the use of a web site together with trading cards imprinted with vendor marketing information, serves to promote brand awareness for the vendor. The inventive system also facilitates the use of promotional giveaways in order to spark interest in the vendor's goods or services. The use of a web site by the trading card provider on the Internet generates new and repeat customer traffic in that customers or visitors to the web sites are encouraged to periodically surf the web site in order to determine whether they hold winning cards for the promotional giveaways or the like. Finally, the present invention provides a system whereby customers are identified online by name, e-mail address and/or physical address all of which are then stored in a database.

The inventive system offers significant benefits for web sites that choose it as a part of their total marketing effort. The inventive system enables client sites to experience the greatest positive impact in the areas of delivering client brand, capturing new traffic, generating repeat traffic, identifying the online consumer, and providing an outsource promotion alternative.

The inventive system efficiently and effectively markets a web site's brand identity to the consumer. The importance of fusing a web site's name, image, and associated area of expertise into the mind of a consumer is critical. The tangible, collectible trading card in electronic or hard copy form reinforces a web site's brand image and specialty area. Because the trading card itself represents a promotion of inherent value, consumers want to receive one and initiate participation, which pushes the effective transmission of client brand to unparalleled extremes. Whether it is next to the computer, in a mail pile, or on an office desk, the trading card provides a great platform for delivering the site's brand into the homes and businesses of those valued online consumers. The trading card represents a solid medium for sharing the fun and enjoyment of the Internet.

The inventive system creates several avenues for generating new traffic. The associated web site displays in catalog form each site's card image, location hyperlink, promotional summary, and card availability status. This card catalog generates new interest as people see in virtual form the trading cards themselves and not the promotional offers resulting from a site visit. As the number of participating sites increases and card popularity grows, so will the perpetual stream of referral traffic generated and channeled through the web site. The valued promotion, offered in conjunction with the trading card, may lead some online consumers to sites that they would not normally visit, thus increasing the traffic and exposure a site would otherwise receive. Client sites that create visually outstanding cards will receive new traffic from those consumers interested in the card's unique artistic composition.

The inventive system maintains several features that will create repeat traffic. Repeat traffic, otherwise quantified as a site's “stickiness” factor, is a critical component of healthy e-commerce. The colorful, tangible, and eye-catching trading card will aid in creating brand loyalty by reminding the online consumer of the site and its location on the web. Promotional giveaways encourage repeat traffic as trading cardholders re-visit sites while looking for their winning number. The frequency of each giveaway can be adjusted to fit the site's mission, visitor pool, and demographic makeup. The trading cards can be re-designed and re-issued periodically in electronic or hard copy form so as to attract new interest and encourage repeat visits.

In addition to marketing a site's brand and generating web traffic, the inventive system identifies individual online consumers by name and physical address without disrupting their Internet experience. With consumer identification a growing area, e-mail addresses and IP origins no longer suffice as web sites strive to know their visitors by name. The information gathered through the inventive system is no mere “lead list”, but rather a catalog of interested individuals receptively and repeatedly browsing the client site. Those consumers who request a trading card will be inherently more enthusiastic about receiving future marketing material and the subtle promotional message transmitted by the card itself. The contact information collected during the process is given to the web site in formats easily adapted for use in any number of future direct letter, catalog, brochure, magazine, coupon, gift certificate, or other marketing campaigns.

The online consumer benefits from a card that provides a promotional opportunity of inherent value. Depending on the web site's target market, the promotion could take any number of forms. In the case of an online giveaway, a winner would be drawn periodically from the site's pool of participants. Other incentives can include a flat discount or gift certificate toward the purchase of the site's product or service. In any case, the tangible trading card provides an incentive-based value to the online consumer.

The inventive system is also advantageous to consumers, for it delivers a simple, consistent method for participating in multiple web site promotions. The key to cross-site simplicity is the system's ability to relate a participant's e-mail address to his/her contact profile. Equating individuals with their e-mail addresses conveniently gives consumers one less “user ID” to remember. This type of handshake integration allows people to enter multiple promotions using only their e-mail addresses, saving both the time and hassle of having to completely re-register with each site. Some visitors may fine the ease of requesting cards so great that they choose to enter only trading card enabled giveaways. The online consumer can save time hunting for promotional offers by simply visiting the trading card web site.

With a unique design tailored to represent each web site's look and feel, the trading card has characteristics that make it an attractive Internet momento. Whether or not consumers win a contest or find a promotion advantageous, the trading card provides feedback in the form of a unique collectible card delivered via first class mail or electronically.

### BRIEF DESCRIPTION OF THE DRAWINGS

FIG. 1 shows an exemplary embodiment of the invention in schematic form.

FIG. 2 shows the front and back surfaces of the trading card utilized by the system depicted in FIG. 1.

FIG. 3 shows, in schematic form, the consumer initiated request and registration process associated with the system depicted in FIG. 1.

FIG. 4 shows in greater detail, the Internet trading card provider's web site pages associated with the system depicted in FIG. 1.

FIG. 5 shows in greater detail, the web site button or link used to initiate the process associated with the system depicted in FIG. 1.

FIG. 6 shows in greater detail, the steps involved with the consumer's initial request and registration process associated with the system depicted in FIG. 1.

FIG. 7 shows, in still greater detail, the Internet trading card provider's web site “home” page shown in FIG. 4 and depicted in FIG. 1.

FIG. 8 shows, in still greater detail, the Internet trading card provider's web site “card catalogue” page shown in FIG. 4 and depicted in FIG. 1.

FIG. 9 shows in still greater detail, the Internet trading card provider's web site “card catalogue” status page shown in FIG. 4 and depicted in FIG. 1.

### DETAILED DESCRIPTION OF THE INVENTION

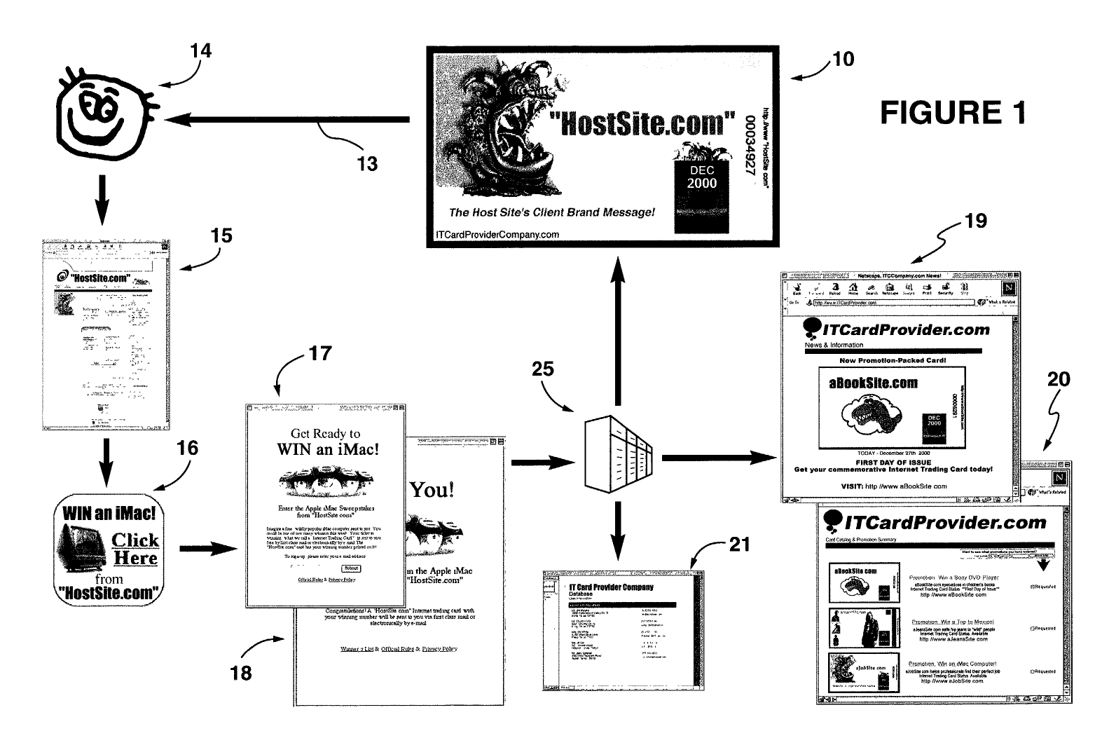

FIG. 1 illustrates a general schematic showing the utilization and implementation of the products, system and method according to the present invention. An “Internet trading card” (hereafter “card”) is illustrated schematically at 10 in FIG. 1. The card 10 is preferably of an inexpensive sheet material such as paper, plastic, paperboard (e.g. typical ID card or sports trading card weight), cardboard, or the like, and are printed with multi colors.

The indicia imaged on the card 10 are designed to promote a company or other entity having a web site, and its domain name. To encourage their collectibility aspects, the cards 10 typically maintain a set of distinguishing characteristics that may include a standardized card logo, date of issuance, multi-color graphic, hologram, a bar code or like machine readable indicia and/or a unique numbering system.

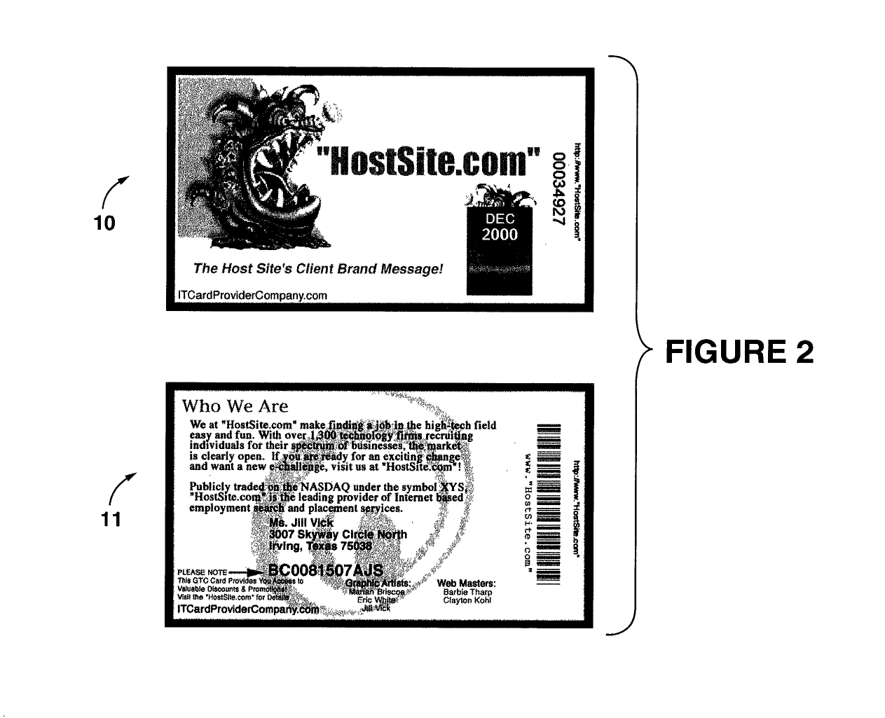

Preferably indicia are provided on both faces of the card. For example the back face of the card 10 is shown at 11 in FIG. 2. Typically the information imaged on the card 10, and face 11 thereof, will focus on providing the host company or other entity with a tangible medium for transmitting their brand identity, business location, product, and/or ideas to consumers. In most cases the artwork and/or images for the cards will be supplied by the host company/entity, and the graphics will be representative of, and focused on, capturing the host sites current look, feel, and theme.

The cards 10 will typically be produced, stored, and sent, by the Internet trading card company (hereafter “card provider”), as one possible implementation, as requested by consumers who chose to participate in the promotion. For example, the card provider will sweep its data base and mail or otherwise transmit to each consumer the cards 10 that have electronically requested by that consumer on that given day. If physically sent, multiple card requests going to the same location may be packaged together, and/or one or more cards 10 may be packaged and distributed with gum, novelty items, candy, or the like, either typically, or for special locations or special web sites. Otherwise, fully functioning electronic versions of the each card can be sent immediately via the global computer network, lacking only the more tangible marketing aspects of the physical delivery.

FIG. 1 schematically illustrates by arrow 13 the transmittal of the cards 10 to the consumer 14, by either physical or electronic delivery, who the companies or entities participating in the card program seek to identify, understand, and market to directly.

FIG. 1 also schematically illustrates the client (hereafter “host site”) 15 on a global computer network, which the consumer 14 accesses in a conventional manner (e.g. a personal computer with a modem and browser). The host site 15 provides an electronic link button, schematically illustrated at 16 in FIG. 1, for requesting entry into the promotion and subsequently a card 10 designed to promote the company or other entity and its domain name that controls the host site 15.

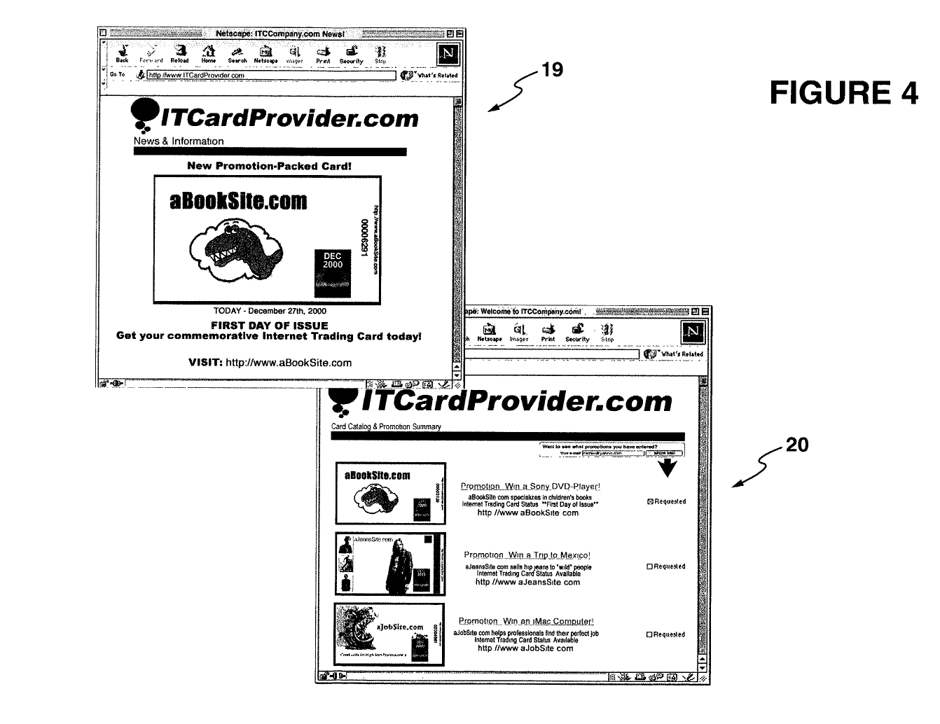

The host sites 15 benefit from, among other things, the building of client brand, repeat visits, direct marketing opportunities, and contact information, for each individual consumer requesting entry into the promotion. New traffic is typically generated from these consumers using the links provided at the card producer's own web site, shown in illustrations19 and 20 in FIGS. 1 and 4, to increase interest in the host sites and promote the collectibility of the cards themselves. The schematically illustrated web site screens 17, 18, 19, 20, and 21, are designed, provided, and maintained, by the card provider itself to facilitate and market the promotion (“ITCardProvider” in the drawings).

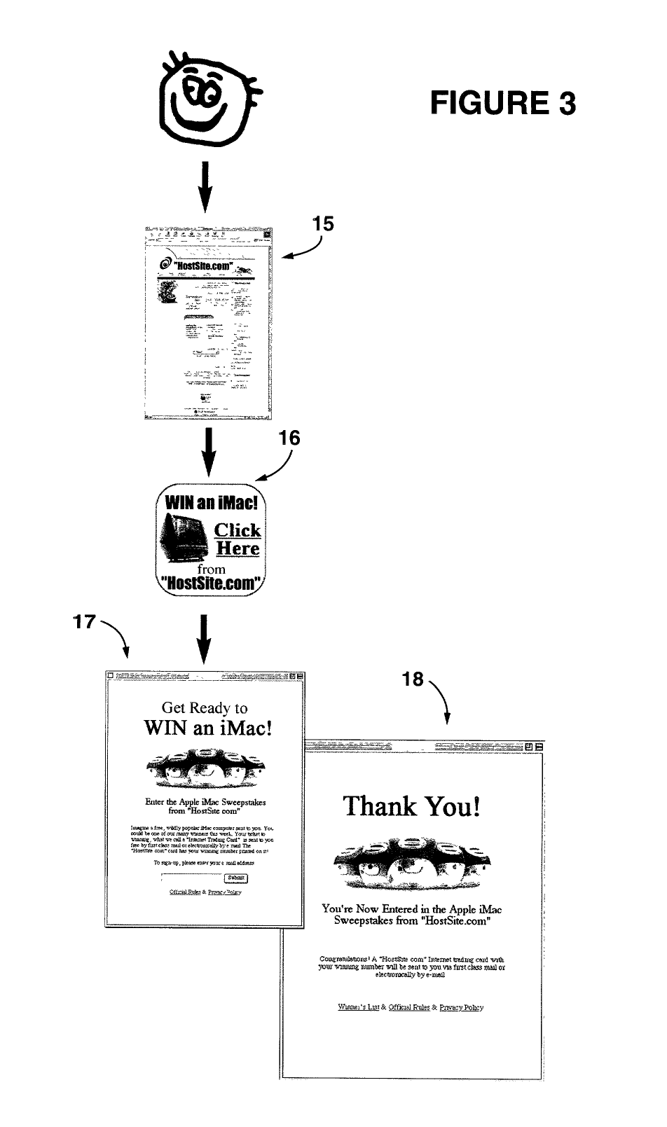

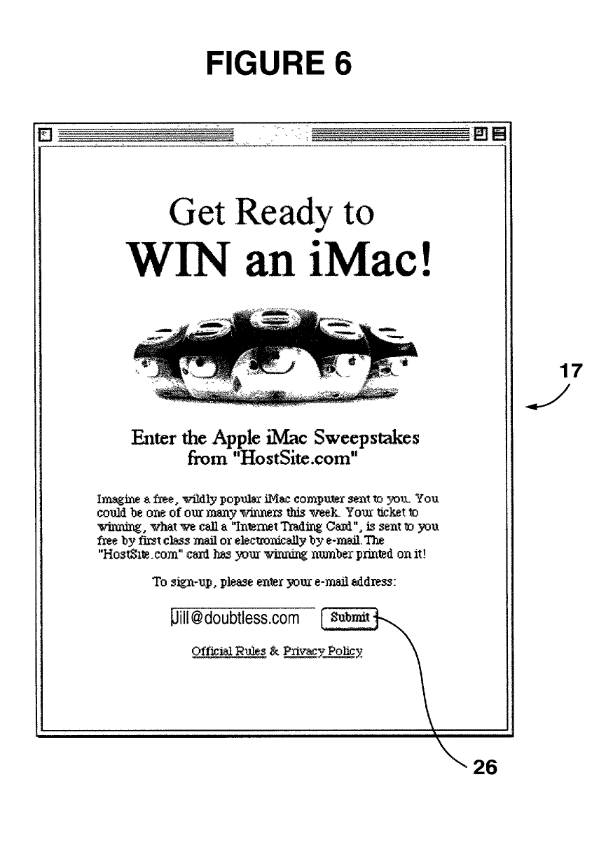

The link button 16 is used to register a consumer's interest in receiving a card 10. If the consumer is not registered, he/she will be brought to a new user registration form, shown by screens 17 and 18 in FIGS. 1, 3, and 6. Once registered, the consumer needs only to press the link button 16 and type their e-mail address to request another host site's card, making the process quick and fun. The new registration screens 17, 18 are shown in more detail in FIGS. 3 and 6. In addition to a new user registration, at one of the screens 17, 18, a method of looking up user names that are lost or forgotten or the modification of an address that has been changed is provided (not shown).

A conventional server 25 is provided at the card production/distribution entity's site, to collect information about each consumer. In addition to data storage, the server 25 hosts a web location for consumers wanting to visit other sites participating in the card system. Exemplary screens of the card provider's site shows the card promotion and the card catalogue designed to peak consumer interests in other participating host sites, promotions, and cards, as shown in illustrations 19, 20 in FIGS. 1 and 4. The screens 19, 20 at the card provider's site provide consumers with news, information, and access to accessory products, and promote the collectible aspects of the cards 10 themselves. The web site features a “virtual card catalog” 20 that displays a picture of each client site's card followed by an enticing description of the promotion and a link to connect them with the web site. With the click of a mouse, consumers can easily visit the numerous linked sites and enter multiple giveaways, sweepstakes, and incentive programs tied to the unique number found on each issued card.

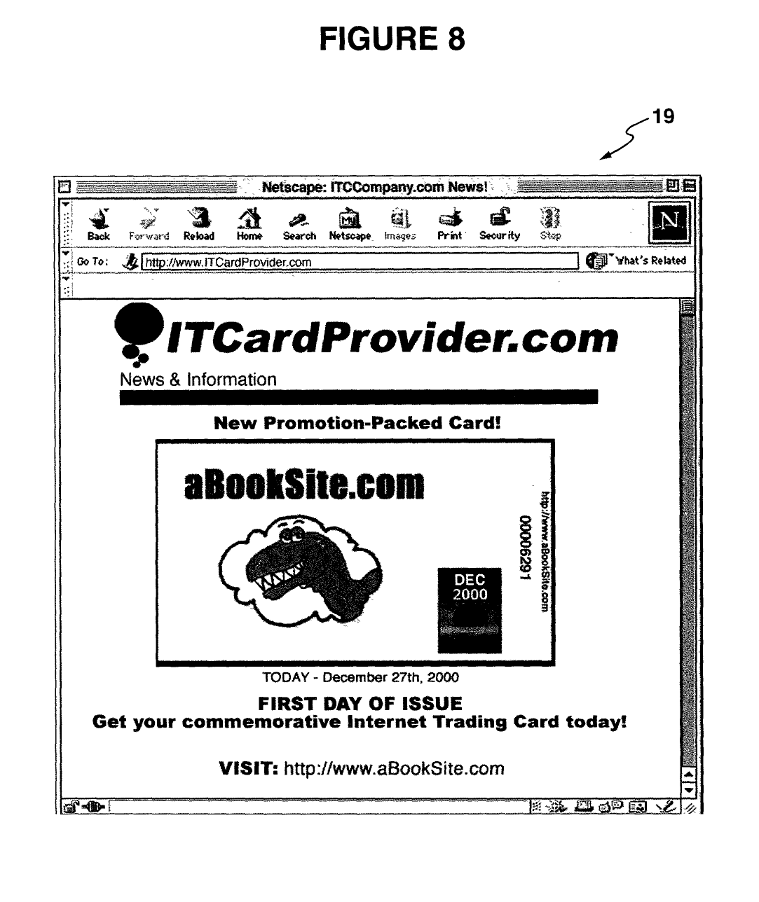

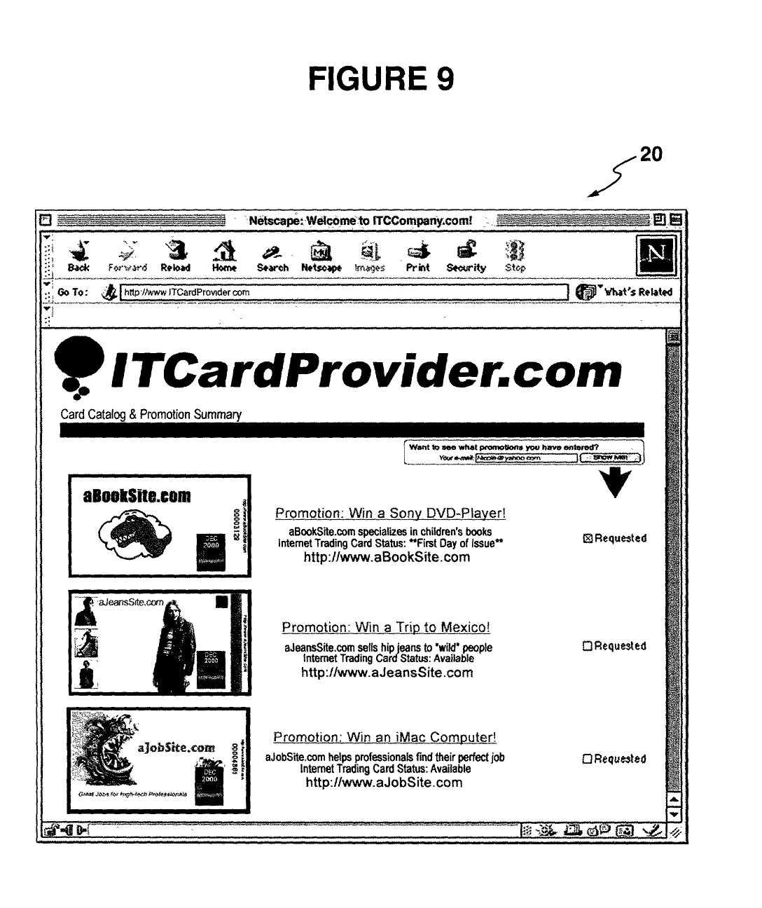

The screens 19, 20 are shown in more detail in FIG. 4 and still greater detail in FIGS. 8 and 9. The card provider's site, as exemplified by screens 19 and 20, may be designed for providing information to consumer users, and collectors, alike. The site will promote cards and their respective host sites.

The server 25 is operatively connected to the database 21. Host sites receive information on those consumers who visit their site and request a card. Information on other consumers using the card system can be purchased from the card provider. User information from the card provider can also be updated and distributed to host sites 15 by the server 25 which a direct data base link, and/or a removable medium disk, or the like.

For example, in an effort to encourage the collectibility aspects of the cards 10 themselves, consumers may be notified (by server 25) of the newest additions and updates to the card collection (e.g. first day issue cards, statistics on the number of cards issued, commemorative offers, promotional giveaways based on a cards unique number, etc., such as schematically illustrated on screens 19 in FIGS. 4 and 8). Also the card provider site will give the consumer the status/completeness of the collection, for example listing all of cards requested, available, back ordered, etc as illustrated on screen 20 in FIGS. 4 and 9. Also the card provider web site may offer other products associated with the cards themselves, such as card binders, bar code readers, collection reference CDs, etc.

In a standard implementation of the invention, one or more unique cards represent a host company, its site content, and location. To request the host's card the consumer must visit the host site over a global computer network using the customer's p.c., modem and browser. Once at the host site, the consumer clicks on (with the p.c.'s mouse) the link button 16 to indicate his/her interest in receiving a card 10. The card 10 selected is subsequently shipped or transmitted by the card provider, after processing by the server 25. Once received, the consumer can participate in the promotion by using the unique number found on the card.

The cards 10 can be manufactured at any location, such as the card provider's actual site (or contracted out), and typically are produced using conventional high-speed imaging equipment.

For purposes of describing the inventive system's operation a promotion for a fictitious HostSite.com is used in the following text.

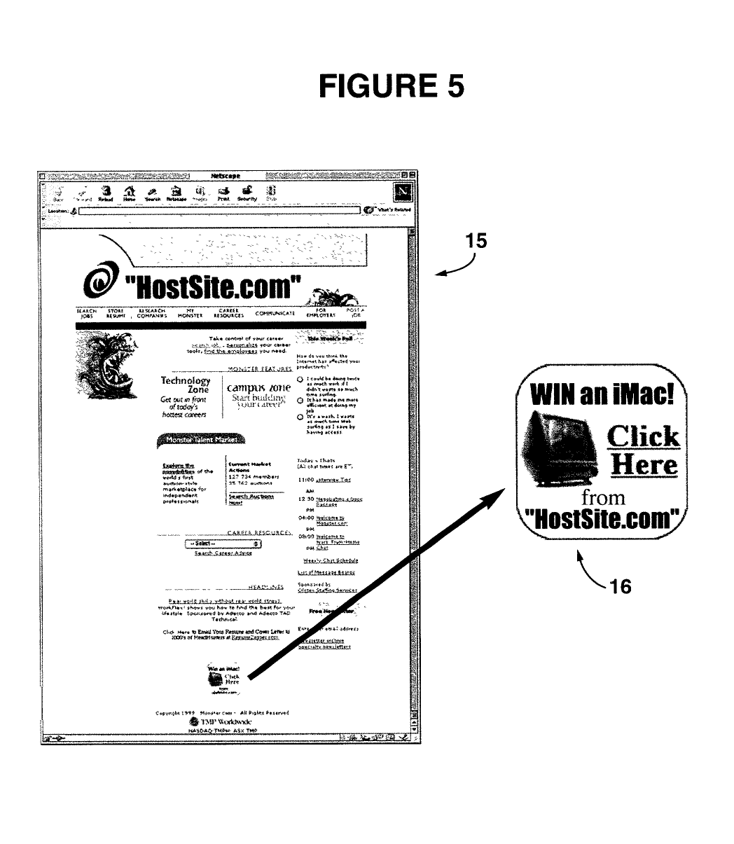

To initiate the process and enter the promotion, the online consumer presses an entry button located on the host site's home page. As seen in FIG. 5, the button 16 itself can take any number of forms and is specifically developed to capture the site's target audience. A collaborative design effort between the host site and the card provider company ensures an entry button that meets that site's requirements. The web site channels traffic by generating excitement and interest in the promotion. Additional marketing efforts performed by the host site only complement the effectiveness of the inventive system. The production and distribution of banner ads and targeted e-mails are offered as additional services by the card company.

Once entry button 16 is pressed, a new window 17 appears through the consumer's Internet browser as shown in FIGS. 3 and 6. The text and graphics within the window describe the exciting promotion and in this example, the prize. In addition, the consumer can access the official contest rules, winners' list, and privacy policy. To sign-up, the consumer simply enters their e-mail address. As shown in FIG. 6, the consumer has entered her e-mail address “Jill@doubtless.com.”

At the moment submit button 26 is pressed in window 17, an almost instantaneous database check confirms whether or not the individual had entered any previous promotion. The check step is necessary, for it verifies that both the name and physical address are held in the database for use in the automatic registration and delivery of the numbered card. If a name and address is confirmed, a simple “Thank You” message is shown, and an entry confirmation e-mail is sent to the consumer.

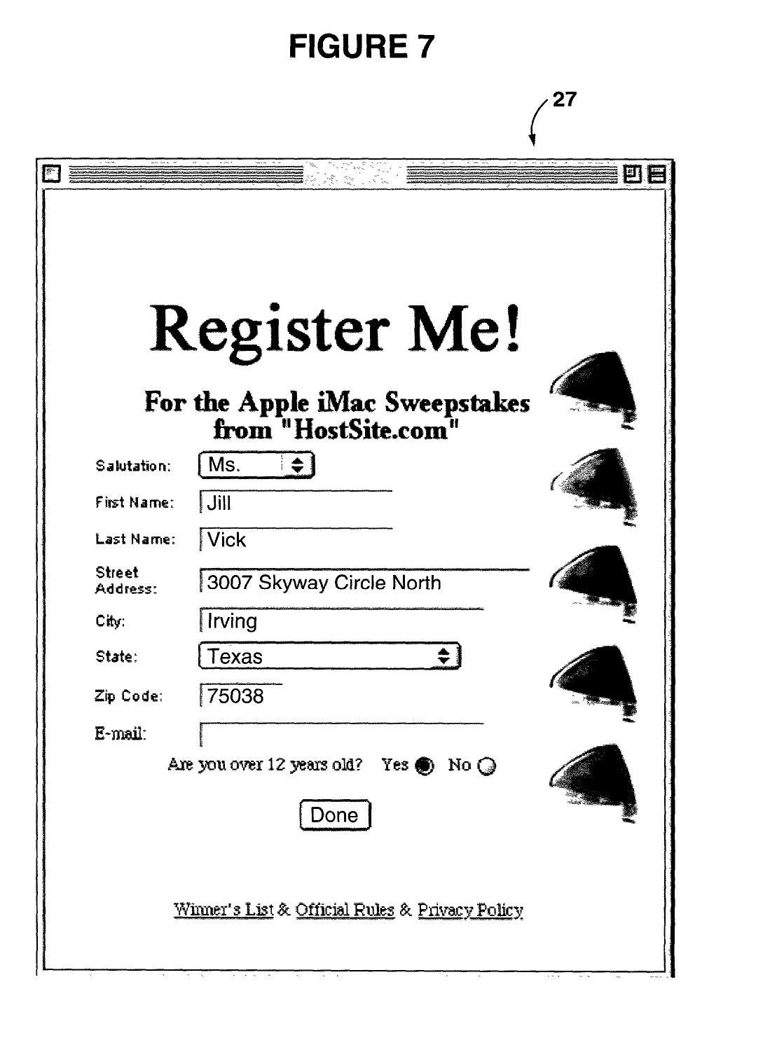

If on the other hand, the e-mail address is unrecognized, a register form 27 appears. As shown in FIG. 7, the register form 27 is quick, easy, and noninvasive. Once the brief form is completed, a confirmation is immediately e-mailed to the newly-entered participant. From this point forward, the individual's e-mail address is linked to their physical address making all future participation nearly effortless.

As seen above, the card company has requested only the most basic contact information required for a successful entry and card delivery. The focus is to keep the promotions timely and fun. The card company does not want to burden the consumer with intrusive questions or associate itself with potentially sensitive information. Note that Federal law prohibits online gathering of identifying information about children under 13 years of age without parental consent. Every facet of the inventive system is voluntary.

Once the entry is submitted, the client's card can be sent to the consumer via the U.S. Postal Service first-class mail system, electronically over the global computer network or by any other suitable delivery system. Depending on fulfillment requirements, the physical card can be sent on its own or mailed in some type of envelope, for example, equipped with a cutout window positioned to expose the mailing information.

The inventive system distributes cards in a limited edition fashion. Annually, a web site client would only make available a specified number of cards to the public. The number of cards chosen by the client site would represent a theoretical maximum of which some or all may be requested. It may be desirable for a portion of the cards to be made available starting on the first day of each month for request by the online consuming public. If the card is popular and demand exceeds that month's supply, those requests above and beyond the allocated level may receive a virtual card.

The virtual card can be sent via e-mail and delivers the same features to the consumer but in an electronic form. This overflow system allows online consumers to participate in a site's giveaway and sign-up as new users even if the card for that particular site is unavailable at the time.

The contact information gleaned from the registration process is stored in a database and shared with those sites from which each card request originates. For every card sent to an online consumer, the site holder receives the e-mail address, contact name and physical address for that web visitor. The sites may acquire their respective consumer database online or in the form of a compact disc (“CD”) updated and mailed biweekly. The CD will contain both the contact information and the software necessary to mine, manipulate, and use the data collected.

The card itself as noted above, is a colorful, glossy, two-sided, UV-coated card constructed from a relatively thick cardboard material. As shown in FIG. 2, the front side 10 of the card contains the domain name and graphics intended to capture a web sites current location, look, and feel. In addition to the web site's graphics, a custom hologram, color pattern, and issuance number is used to distinguishably heighten the perceived value and consumer appeal of the card itself.

The card's backside 11 features a mailing label, a company description, and a list of those individuals who made the cyber site truly unique. The mailing label houses an alphanumeric code that serves as the winning number for the site's ongoing series of online promotions. This unique number, tied electronically to the card recipient's name and address, will eliminate duplicate winners and will help to mitigate the potential for fraud. The client is given the opportunity to describe itself in its own words in the “Who We Are” section. Also the site's content managers and graphic artists can be honored by having their names printed onto the card.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed:

1. A vendor marketing system comprising:
a web site for promoting the distribution of vendor oriented information;
trading cards imprinted with vendor information, said trading cards being distributed to visitors of said web site;
wherein said web site contains a registration means whereby visitors to said web site can request specific ones of trading cards, said web site maintaining a virtual card catalogue which displays a plurality of said trading cards being specifically associated with one or more of a plurality of vendors.

2. A vendor marketing system as in claim 1, each one of said plurality of trading card further containing a unique identification number.

3. A vendor marketing system as in claim 2, said web site posting winning identification numbers that can be matched by recipients to their said trading cards to win a gift or promotion offered by one of said plurality of vendors.

4. A vendor marketing system as in claim 2, said web site containing links to other web sites where winning identification numbers are posted so that recipients of said trading cards can match the unique identification numbers carried by their said trading cards to said winning identification number to win a gift or promotion offered by one of said plurality of vendors.

5. A vendor marketing system as in claim 1, further comprising data base storage means for maintaining registration information received from visitors to said web site requesting said trading cards.

6. A vendor marketing system as in claim 1 wherein said trading cards are distributed electronically to visitors of said web site.

7. A vendor marketing system as in claim 1 wherein said trading cards are distributed by mail to visitors of said web site.

8. A trading card distribution system, comprising:
a web site for displaying a virtual catalogue of trading cards, a registration request form for visitors of said web site to provide identifying information, and a selection means for visitors of said web site to identify selections from said virtual catalogue of trading cards; and
a plurality of trading cards corresponding to said virtual catalogue of trading cards, each one of said plurality of trading cards containing specific vendor information;
wherein specific selected ones of said trading cards are distributed to visitors of said web site in accordance with the identifying information provided by said visitors.

9. A trading card distribution system as in claim 8, each one of said plurality of trading cards further containing a unique identification number.

10. A trading card distribution system as in claim 9, said web site posting winning identification numbers that can be matched by recipients to their said trading cards to win a gift or promotion offered by one of said plurality of vendors.

11. A trading card distribution system as in claim 9, said web site containing links to other web sites where winning identification numbers are posted so that recipients of said trading cards can match the unique identification numbers carried by their said trading cards to said winning identification number to win a gift or promotion offered by one of said plurality of vendors.

12. A trading card distribution system as in claim 8, further comprising data base storage means for maintaining registration information received from visitors to said web site requesting said trading cards.

13. A trading card distribution system as in claim 8 wherein said trading cards are distributed electronically.

14. A trading card distribution system as in claim 8 wherein said trading cards are distributed by mail.

15. A vendor marketing method comprising the steps of:
establishing a web site for promoting the distribution of vendor oriented information; and
distributing trading cards imprinted with vendor information to visitors of said web site;
wherein said web site contains a registration means whereby visitors to said web site can request specific ones of trading cards, said web site maintaining a virtual card catalog which displays a plurality of said trading cards being specifically associated with one or more of a plurality of vendors.

16. A vendor marketing method as in claim 15, each one of said plurality of trading card further containing a unique identification number.

17. A vendor marketing method as in claim 16, said web site posting winning identification numbers that can be matched by recipients to their said trading cards to win a gift or promotion offered by one of said plurality of vendors.

18. A vendor marketing method as in claim 16, said web site containing links to other web sites where winning identification numbers are posted so that recipients of said trading cards can match the unique identification numbers carried by their said trading cards to said winning identification number to win a gift or promotion offered by one of said plurality of vendors.

19. A vendor marketing method as in claim 15, further comprising data base storage means for maintaining registration information received from visitors to said web site requesting said trading cards.

20. A vendor marketing method as in claim 15 wherein said trading cards are distributed electronically to visitors of said web site.

21. A vendor marketing method as in claim 15 wherein said trading cards are distributed by mail to visitors of said web site.

22. A trading card distribution method, comprising:
establishing a web site for displaying a virtual catalogue of trading cards, a registration request form for visitors of said web site to provide identifying information, and a selection means for visitors of said web site to identify selections from said virtual catalogue of trading cards; and
distributing a plurality of trading cards corresponding to said virtual catalogue of trading cards, each one of said plurality of trading cards containing specific vendor information;
wherein specific selected ones of said trading cards are distributed to visitors of said web site in accordance with the identifying information provided by said visitors.

23. A trading card distribution method as in claim 22, each one of said plurality of trading cards further containing a unique identification number.

24. A trading card distribution method as in claim 23, said web site posting winning identification numbers that can be matched by recipients to their said trading cards to win a gift or promotion offered by one of said plurality of vendors.

25. A trading card distribution method as in claim 23, said web site containing links to other web sites where winning identification numbers are posted so that recipients of said trading cards can match the unique identification numbers carried by their said trading cards to said winning identification number to win a gift or promotion offered by one of said plurality of vendors.

26. A trading card distribution method as in claim 22, further comprising data base storage means for maintaining registration information received from visitors to said web site requesting said trading cards.

27. A trading card distribution method as in claim 22 wherein said trading cards are distributed electronically.

28. A trading card distribution method as in claim 22 wherein said trading cards are distributed by mail.
